(19) United States
(12) Patent Application Publication
(10) Pub. No.: US 2004/0154119 A1
(43) Pub. Date: Aug. 12, 2004

(54) Liquid application tool with flexible arm

(76) Inventor: Terry Bullock, Poplar Bluff, MO (US)

Correspondence Address: THOMAS B. LUEBBERING, HOVEY WILLIAMS LLP, Suite 400, 2405 Grand, Kansas City, MO, 64108, US

(21) Appl. No.: 10/364,582

(22) Filed: Feb. 10, 2003

(51) Int. Cl. A46B 7/02; B05C 17/02

(52) U.S. Cl. 15/172; 15/144.1; 15/144.2; 15/230.11; 492/13; 492/19

(57) ABSTRACT

A liquid application tool (10,110) that holds a liquid applicator (14) at an angle to a handle (12,112). The tool (10,110) broadly comprises a handle (12,112), a liquid applicator (14,114) and a flexible arm (16,116) between the handle (12,112) and the applicator (14,114). The handle (12,112) may be adapted to be held in a user's hand. The applicator (14,114) preferably comprises a roller assembly (32) capable of holding a paint roller. The arm (16) preferably comprises L-shaped segments (20,22) joined by an adjustable joint (24) in order to adjust the angle. Alternatively, the flexible arm (116) may bend along at least a portion of its length in order to adjust the angle.

### BACKGROUND OF THE INVENTION

1. Field of the Invention

The present invention relates to liquid application tools such as paint brushes and rollers. More particularly, the present invention relates to a liquid application tool with a flexible arm which can hold a liquid applicator at various angles relative to a handle.

2. Description of Prior Art

Painters use various types of brushes, rollers and other liquid application tools to apply paint and other substances to various surfaces. In order to cover high portions of walls and other hard to reach surfaces, painters often use extension poles for their application tools. For example, paint rollers can be mounted on extension poles which allow painters to reach well above their heads.

However, using extension poles with paint rollers to paint high places presents a challenge to painters in that it becomes difficult, if not impossible, to roll paint rollers along a path not parallel to the extension pole. For example, a painter painting a house may use a paint roller on an extension pole to paint the house's eaves. The painter cannot easily roll the paint roller parallel to a slanted roof in order to paint the house's eves because he would have to stand where he could hold the extension pole at an angle parallel to the slanted roof. This may require the painter to stand a considerable distance from the house and use an extension pole of unreasonable length. Such an extension pole would be too heavy and/or awkward to use.

Accordingly, there is a need for an improved liquid application tool which overcomes this limitation.

### SUMMARY OF THE INVENTION

The present invention overcomes the above-identified limitations and provides a distinct advance in the art of liquid application tools. More particularly, the present invention provides a liquid application tool with a flexible arm which can hold a liquid applicator at various angles relative to a handle.

A preferred first embodiment of the present invention broadly comprises a handle, a liquid applicator, and a flexible arm between the handle and the applicator. The flexible arm preferably comprises a plurality of substantially rigid arm segments of various shapes and sizes connected by one or more adjustable joints. Each adjustable joint allows the segments to pivot about at least one axis, thereby changing an angle between the handle and the applicator.

A preferred second embodiment of the present invention broadly comprises a handle, a liquid applicator, and a flexible arm between the handle and the applicator. The flexible arm is preferably operable to bend along at least a portion of its length, thereby changing an angle between the handle and the applicator.

### BRIEF DESCRIPTION OF THE DRAWINGS

A preferred embodiment of the present invention is described in detail below with reference to the attached drawing figures, wherein:

FIG. 1 is a perspective view of a preferred first embodiment of a liquid application tool constructed in accordance with the present invention;

FIG. 2 is a perspective view of the liquid application tool including a plurality of adjustable joints;

FIG. 3 is a perspective view of the liquid application tool including a U-shaped arm segment;

FIG. 4 is a perspective view of the liquid application tool including a joint operable to rotate about multiple axes; and

FIG. 5 is a perspective view of a preferred second embodiment of the liquid application tool constructed in accordance with the present invention including a bendable arm segment.

### DETAILED DESCRIPTION OF PREFERRED EMBODIMENTS

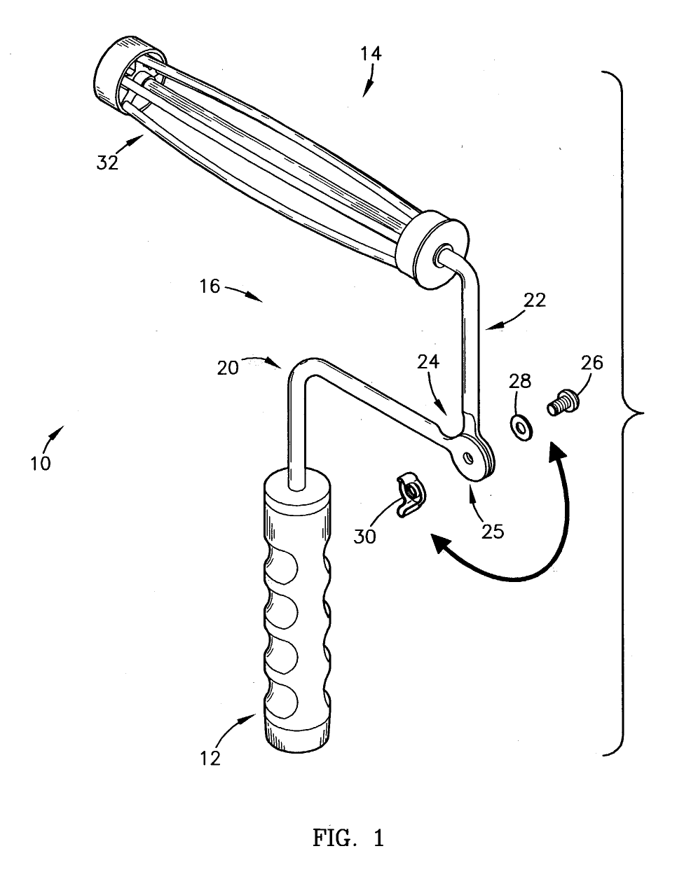

Referring to FIG. 1, a preferred first embodiment of a liquid application tool 10 constructed in accordance with the present invention is illustrated. The tool 10 comprises a handle 12, an applicator 14 supported by the handle 12, and a flexible arm 16 between the handle 12 and the applicator 14.

The handle 12 allows a user to hold the tool 10 and is preferably attached to the arm 16, but may be operable to be attached to and removed from the arm 16 at the user's discretion. The handle 12 is preferably three to eight inches in length and between one-half and two inches in diameter. The handle 12 is preferably made of plastic, but may be made of another hard material, such as wood or metal. Alternatively, the handle 12 may be made of a soft material, such as rubber, or a combination of hard and soft materials. The handle 12 is preferably substantially cylindrical and preferably adapted to be held in the user's hand. As such, the handle 12 may include ridges which fit between the user's fingers, and contours which allow the handle 12 to fit comfortably into the user's palm. The handle 12 may also include a coupler which enables the handle 12 to attach to an extension device, such as a long and/or extendable pole. The coupler may be male or female, may be threaded, and may be integral to or detachable from the handle 12.

The flexible arm 16 allows the user to adjust an angle between the handle 12 and the applicator 14. The flexible arm 16 preferably comprises a first substantially rigid L-shaped arm segment 20, a second substantially rigid L-shaped arm segment 22, and an adjustable joint 24 joining the L-shaped segments 20,22.

The L-shaped segments 20,22 are preferably made of metal, but may be made of plastic or another substantially rigid material.

The first L-shaped segment 20 is preferably attached to the handle 12, and comprises a first leg and a second leg. The first leg is preferably approximately three inches in length and the second leg is preferably approximately five inches in length, but the length of each leg may be between one-half and ten inches.

The second L-shaped segment 22 is preferably attached to the applicator 14, and comprises a first leg and a second leg. The first leg is preferably approximately four and one-half inches in length and the second leg is preferably approximately one inch in length, but the length of each leg may be between one-half and ten inches.

The joint 24 lies between and joins the L-shaped segments 20,22, allowing them to pivot about an axis thereby adjusting the angle between the handle 12 and the applicator 14. The joint 24 preferably comprises flat round ends 25 of the L-shaped segments 20,22 that are held together by a bolt assembly comprising a bolt 26, a washer 28 and a wingnut 30. The bolt 26 is preferably inserted through the washer 28 and the ends 25 of the L-shaped segments 20,22, and secured in place with the wingnut 30. The joint 24 may be locked into place or made adjustable by tightening or loosening the wingnut 30, respectively. The joint 24 may include notches or detents operable to allow the joint 24 to be positioned at specific angles.

The applicator 14 preferably comprises a roller assembly 32 with a cylindrical wire cage rotatably attached to the second L-shaped segment 22. The roller assembly 32 may hold a paint roller or similar device which is capable of picking up and applying liquids such as paints, adhesives, or sealants. Alternatively, the applicator 14 may comprise a brush, a sponge or another device useful for applying liquids.

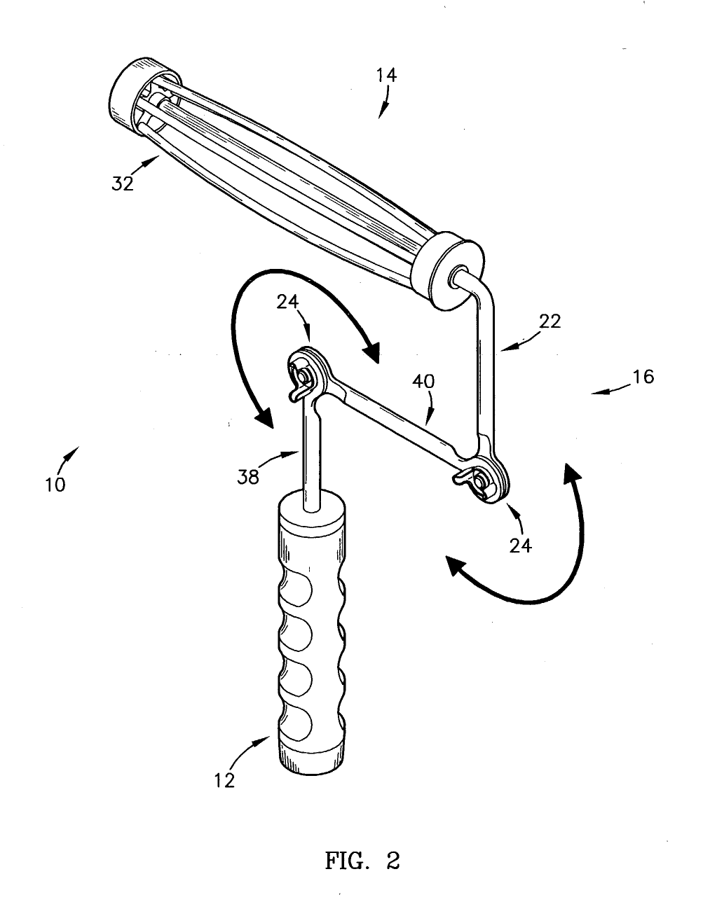

As shown in FIG. 2, the flexible arm 16 may differ from that described above. For example, the flexible arm 16 may comprise a first substantially rigid straight arm segment 38 attached to the handle 12, a second substantially rigid straight arm segment 40, and the second L-shaped segment 22 described above. These segments 22,38,40 are preferably hingedly attached by two of the adjustable joints 24 described above. While, as shown in FIG. 2, the joints 24 may be aligned in a planar arrangement, the joints 24 may be aligned so that the flexible arm 16 may articulate three dimensionally.

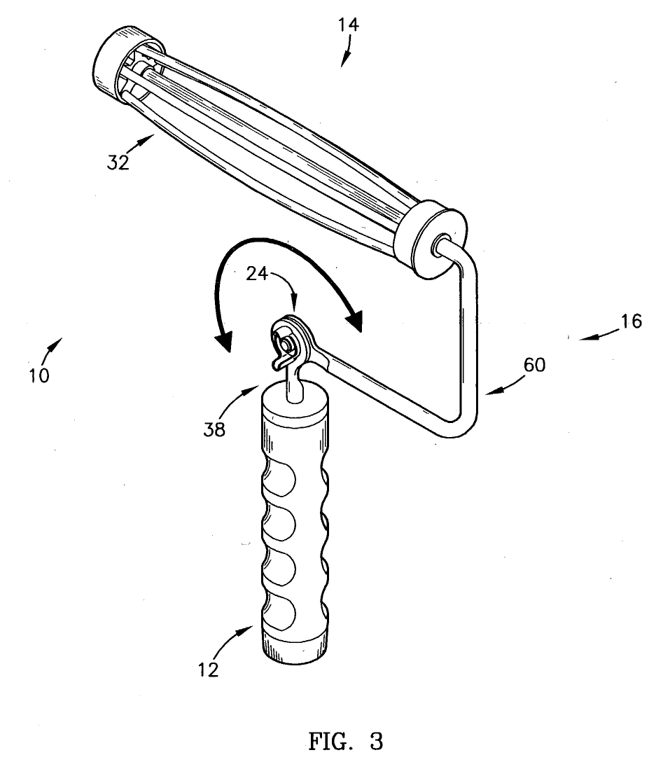

Additionally, as shown in FIG. 3, the joint 24 may be located at different places along the flexible arm 16. For example, the joint 24 may be located between the first straight segment 38 described above and a substantially rigid U-shaped segment 60. The U-shaped segment 60 is preferably attached to the applicator 14 in a manner similar to that described for the second L-shaped segment 22.

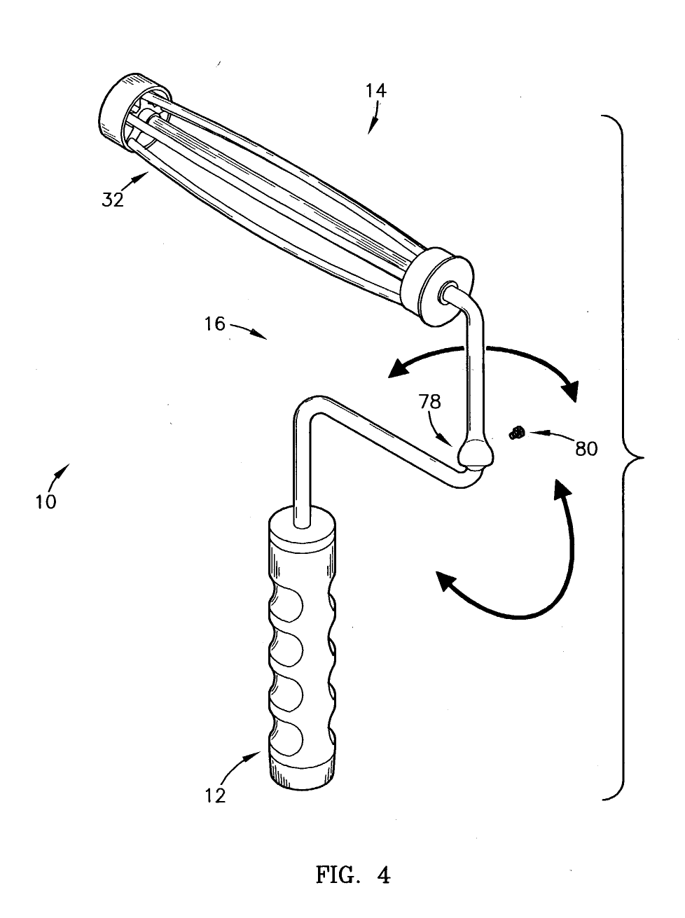

Additionally, as shown in FIG. 4, the flexible arm 16 may comprise a multiple axis adjustable joint 78, such as a ball and socket joint. In this case, the joint 78 may allow the angle between the handle 12 and the applicator 14 to be adjusted with respect to two or more axes. The joint 78 preferably uses a set-screw 80 to hold a specific angle between the handle 12 and the applicator 14. Alternatively, the joint 78 may use tension to hold the specific angle between the handle 12 and the applicator 14.

In use, the user holds the tool 10 by the handle 12 to apply a liquid to a surface with the applicator 14. The user can loosen the wing nut 30 on the joint 24, place the applicator 14 at a desired angle relative to the handle 12, and then tighten the wing nut 30 to lock the applicator 14 at the desired angle. Alternatively, the user may loosen and then tighten the set screw 80 on the multiple axis adjustable joint 78 to lock the applicator 14 at the desired angle.

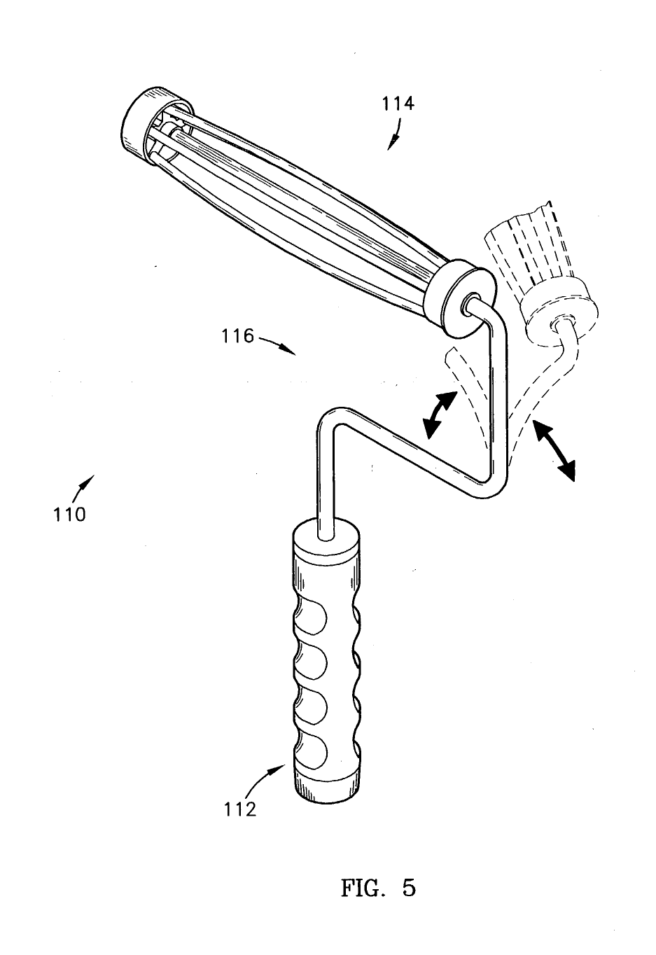

Referring to FIG. 5, a preferred second embodiment of a liquid application tool 110 constructed in accordance with the present invention is illustrated. The tool 110 broadly comprises a handle 112 and a liquid applicator 114 with a flexible arm 116 therebetween. The handle 112 and the applicator 114 are preferably identical to the handle 12 and the applicator 14 described above. The flexible arm 116 is preferably bendable along its entire length, but may be bendable along only one or more portions of the length. The flexible arm 116 is preferably made of a malleable material such as metal. Alternatively, the flexible arm 116 may comprise a plurality of joints which may be joined by small rigid segments. Furthermore, the flexible arm 116 may be made of a braided material.

In use, a user holds the tool 110 by the handle 112 to apply the liquid to the surface with the applicator 114. The user can change the angle between the handle 112 and the applicator 114 by forcibly bending the arm 116 and thereby moving the applicator 114 to the desired angle.

While the present invention has been described above, it is understood that other materials and dimensions can be substituted. For example, while the segments 20,22,38,40,60 have been described above as L-shaped, straight and U-shaped, respectively, the flexible arm 16,116 may comprise arm segments of varying shapes and sizes. Furthermore, the L-shaped segments 20,22 and the U-shaped segment 60 may have substantially squared or rounded corners. These and other minor modifications are within the scope of the invention.

Having thus described preferred embodiments of the invention, what is claimed as new and desired to be protected by Letters Patent includes the following:

1. A liquid application tool comprising:
a handle;
an applicator supported by the handle at an angle which defines an orientation between the handle and the applicator; and
a flexible arm between the handle and the applicator operable to adjust the angle.

2. The tool in accordance with claim 1, wherein the flexible arm comprises a plurality of substantially rigid arm segments.

3. The tool in accordance with claim 1, wherein the flexible arm comprises at least two substantially rigid arm segments with an adjustable joint therebetween, the joint operable to pivot about an axis.

4. The tool in accordance with claim 1, wherein the flexible arm comprises at least two substantially rigid arm segments with an adjustable joint therebetween, the joint operable to pivot about two axes.

5. The tool in accordance with claim 2, wherein at least one of the segments is substantially L-shaped.

6. The tool in accordance with claim 2, wherein at least one of the segments is substantially L-shaped and contains a substantially squared corner.

7. The tool in accordance with claim 2, wherein at least one of the segments is substantially L-shaped and contains a substantially rounded corner.

8. The tool in accordance with claim 2, wherein at least one of the segments is substantially U-shaped.

9. The tool in accordance with claim 2, wherein at least one of the segments is substantially U-shaped and contains substantially squared corners.

10. The tool in accordance with claim 2, wherein at least one of the segments is substantially U-shaped and contains substantially rounded corners.

11. The tool in accordance with claim 1, wherein the flexible arm is operable to bend along at least a portion of its length and thereby adjust the angle.

12. The tool in accordance with claim 1, wherein the applicator comprises a roller assembly capable of holding a paint roller and is operable to rotatably attach to the flexible arm.

13. The tool in accordance with claim 1, wherein the applicator comprises a brush operable to attach to an end of the flexible arm.

14. A liquid application tool comprising:
a handle;
an applicator supported by the handle at an angle between the handle and the applicator; and
a flexible arm between the handle and the applicator comprising at least two substantially rigid segments and an adjustable joint therebetween, wherein the joint is operable to pivot about an axis and thereby adjust the angle.

15. The tool in accordance with claim 15, wherein the adjustable joint is operable to pivot about two axes.

16. The tool in accordance with claim 15, wherein the flexible arm further comprises at least two adjustable joints.

17. A liquid application tool comprising:
a handle between four and seven inches in length;
a liquid applicator capable of holding a paint roller;
a first substantially rigid and substantially L-shaped arm segment operable to attach to the handle, comprising a first leg between two and four inches in length and a second leg between four and six inches in length;
a second substantially rigid and substantially L-shaped arm segment operable to attach to the applicator, comprising a first leg between three and five inches in length and a second leg between one-half and two inches in length; and
an adjustable joint between the arm segments operable to adjust an angle between the handle and the applicator by pivoting about an axis.

18. A liquid application tool with a handle and an applicator, the tool comprising:
a flexible arm operable to attach to the handle the applicator, wherein the arm is operable to bend along at least a portion of its length and thereby adjust an angle between the handle and the applicator.
